(19) United States
(12) Patent Application Publication
(10) Pub. No.: US 2025/0353436 A1
(43) Pub. Date: Nov. 20, 2025

(54) DEVICE AND METHOD FOR OBTAINING A REAR VIEW OF A VEHICLE

(71) Applicants: HYUNDAI MOTOR COMPANY, Seoul (KR); KIA CORPORATION, Seoul (KR)

(72) Inventors: Yunjoong Park, Hwaseong-si (KR); Jeongtaek Oh, Hwaseong-si (KR)

(73) Assignees: HYUNDAI MOTOR COMPANY, Seoul (KR); KIA CORPORATION, Seoul (KR)

(21) Appl. No.: 18/963,053

(22) Filed: Nov. 27, 2024

(30) Foreign Application Priority Data
May 17, 2024 (KR) 10-2024-0064840

(51) Int. Cl. B60R 1/26; G06V 20/58; H04N 7/18

(52) U.S. Cl. CPC B60R 1/26; G06V 20/58; H04N 7/181; B60R 2300/105

(57) ABSTRACT

A device for obtaining a rear view of a vehicle includes: a first rear camera installed on a rear side of the vehicle to capture a first rear view image; a second rear camera installed on an inner edge portion of the vehicle and capturing a second rear view image; a sensor unit for generating a first sensing signal and a second sensing signal; a control unit for receiving the first and second sensing signals, determining whether a state of the gear of the vehicle is in a reverse state and whether the rear door is open or closed, and generating a control signal for outputting at least one of the first rear view image or the second rear view image; and a display unit to display at least one of the first rear view image or the second rear view image.

### CROSS-REFERENCE TO RELATED APPLICATION

This application claims priority to and the benefit of Korean Patent Application No. 10-2024-0064840 filed in the Korean Intellectual Property Office on May 17, 2024, the entire contents of which are incorporated herein by reference.

### BACKGROUND

### (a) Technical Field

The present disclosure relates to a device and a method for obtaining a rear view of a vehicle having a cargo compartment for storing cargo.

### (b) Description of the Related Art

In general, it is relatively easy for a driver to monitor the front area of a vehicle, but relatively difficult to monitor the lateral side or the backward side (i.e., the rear or rear side). This creates blind spots during the vehicle's operation. Most accidents that occur during operation, such as fatalities or damage to structures, occur in these blind spots. In particular, commercial vehicles, such as vehicles, have a higher possibility of safety accidents occurring than smaller vehicles because the obstruction of view by the vehicle itself is relatively larger.

To this end, the vehicle is equipped with at least one mirror that allows the driver to monitor the blind spots. However, monitoring through mirrors requires constant attention from the driver, which increases driver fatigue, and in the case of commercial vehicles, there are limitations in promoting safe driving because the obstruction of the view by the vehicle itself is large. Therefore, in recent years, front and rear cameras have been installed in or on vehicles. The front and rear view images acquired by the front and rear cameras are output to a display near the driver's seat of the vehicle so that the driver is capable of monitoring the surroundings of the vehicle.

### SUMMARY

The present disclosure attempts to provide a device and a method for obtaining a rear view of a vehicle having a cargo compartment for storing cargo.

An embodiment of the present disclosure provides a device for securing rear vision (i.e., obtaining a rear view) of a vehicle having a cargo compartment for storing cargo. The device includes a first rear camera installed on a rear side of the vehicle. The first rear camera captures a first rear view image. The device further includes a second rear camera installed on an inner edge portion of the vehicle that is exposed to the outside when a rear door is open. The second rear camera captures a second rear view image. The device also includes a sensor unit for generating a first sensing signal indicative of a position according to shift of a gear of the vehicle and a second sensing signal indicative of a state in which the rear door is open. The device further includes a control unit. The control unit receives the first and second sensing signals, determines whether a state of the gear of the vehicle is in a reverse state and whether the rear door is open or closed, and generates a control signal for outputting at least one of the first rear view image or the second rear view image according to a result of the determination. The device also includes a display unit installed inside the vehicle. The display unit displays at least one of the first rear view image or the second rear view image according to an input of the control signal.

The first rear camera may be installed on the rear door of the vehicle.

The sensor unit may include a first detecting sensor and a second detecting sensor. The first detecting sensor may detect a position based on the shift of the gear of the vehicle. The second detecting sensor may detect an opening of the rear door.

The sensor unit may include a third detecting sensor. The third detecting sensor may detect an impact occurring to said vehicle and generate a third sensing signal indicating that the impact has occurred to said vehicle.

When the control unit receives the third sensing signal from the third detecting sensor, the control unit may determine that the impact has occurred to the vehicle and generate a control signal for storing at least one of the first rear view image or the second rear view image in a storage unit.

The control unit may determine that the state of the gear of the vehicle is in a reverse state when the position of the gear indicated in the first sensing signal is in a reverse position.

When the control unit receives the second sensing signal from the sensor unit, the control unit may determine that the rear door is open.

The control unit may generate a control signal for outputting the first rear view image when it is determined that the state of the gear of the vehicle is in the reverse state and the rear door is in a closed state.

The control unit may generate a control signal for outputting the second rear view image when it is determined that the state of the gear of the vehicle is in the reverse state and the rear door is in an open state.

The control unit may generate a control signal for switching a rear view image output through the display unit according to a result of the determination of whether the state of the gear of the vehicle is in the reverse state and a result of the determination of whether the rear door is open or closed.

The control unit may generate a control signal for storing the first rear view image when it is determined that the state of the gear of the vehicle is in the reverse state and the rear door is in a closed state.

The control unit may generate a control signal for storing the second rear view image when it is determined that the state of the gear of the vehicle is in the reverse state and the rear door is in an open state.

Another embodiment of the present disclosure provides a method of securing rear vision of a vehicle having a cargo compartment for storing cargo. The method includes generating, by a sensor unit, a first sensing signal indicative of a position according to shift of a gear of the vehicle and a second sensing signal indicative of a state in which a rear door installed at a rear side of the vehicle is open. The method also includes receiving, by a control unit, the first and second sensing signals and determining, by the control unit, whether a state of the gear of the vehicle is in a reverse state and whether the rear door is open or closed. The method further includes generating, by the control unit, a control signal for outputting at least one of the first rear view image or the second rear view image according to a result of the determination. The method also includes outputting, by a display unit, at least one of the first rear view image or the second rear view image according to an input of the generated control signal.

Generating the second sensing signal may include: detecting, by a first detecting sensor, a position according to the shift of the gear of the vehicle; generating, by the first detecting sensor, the first sensing signal; detecting, by a second detecting sensor, an opening of the rear door; and generating, by the second detecting sensor, the second sensing signal.

Generating the second sensing signal may include: detecting, by a third detecting sensor, an impact occurring to the vehicle; generating, by the third detecting sensor, a third sensing signal; receiving, by the control unit, the third sensing signal to determine whether the impact has occurred to the vehicle; and generating, by the control unit, a control signal for storing at least one of the first rear view image or the second rear view image in a storage unit according to a result of the determination of whether the impact has occurred to the vehicle.

Generating the control signal may include determining that the state of the gear of the vehicle is in a reverse state if a position of the gear indicated in the first sensing signal is in a reverse position and may include, when the second sensing signal is received from the sensor unit, determining that the rear door is open.

Generating the control signal may include: generating a control signal for outputting the first rear view image when it is determined that the state of the gear of the vehicle is in the reverse state and the rear door is in a closed state; and generating a control signal for outputting the second rear view image when it is determined that the state of the gear of the vehicle is in the reverse state and the rear door is in an open state.

Generating the control signal may include: generating a control signal for storing the first rear view image when it is determined that the state of the gear of the vehicle is in the reverse state and the rear door is in a closed state; and generating a control signal for storing the second rear view image when it is determined that the state of the gear of the vehicle is in the reverse state and the rear door is in an open state.

The method may further include: determining, by the control unit, whether opening and closing of the rear door of the vehicle of which the state of the gear is in the reverse state has changed; and generating a control signal for switching a rear view image output through the display unit according to a result of the determination of whether the opening and closing of the rear door has changed.

According to embodiments of the present disclosure, the rear vision (i.e., the rear view) of a driver may be secured (i.e., obtained) even when the driver drives in reverse with the rear door open, providing a safe and convenient driving experience even in complex surrounding environments.

The effects of the present disclosure are not limited to those mentioned above. Other effects not mentioned herein should be apparent to those having ordinary skill in the art from the following description.

### BRIEF DESCRIPTION OF THE DRAWINGS

FIG. 1 is a diagram illustrating an example of a vehicle having a cargo compartment for storing cargo according to an embodiment of the present disclosure.

FIG. 2 is a block diagram illustrating a device for securing rear vision of a vehicle according to an embodiment of the present disclosure.

FIG. 3 is a diagram illustrating a rear side of a vehicle according to an embodiment of the present disclosure.

FIG. 4 is a diagram illustrating an example of a rear door of the vehicle of FIG. 3 in an open state.

FIG. 5 is a diagram illustrating the switching of an image output to a display unit through the device for securing rear vision of the vehicle according to an embodiment of the present disclosure.

FIGS. 6-8 are flowcharts illustrating a method of securing rear vision of a vehicle according to an embodiment of the present disclosure.

### DETAILED DESCRIPTION

In describing embodiments disclosed in the present disclosure, where it has been determined that detailed description relating to well-known functions or configurations may have made the subject matter of embodiments in the present disclosure unnecessarily ambiguous, the detailed description has been omitted. Further, the accompanying drawings are provided for helping to more easily understand embodiments disclosed in the present specification. The technical spirit disclosed in the present specification is not limited by the accompanying drawings, and it should be appreciated that the present disclosure includes all of the modifications, equivalent matters, and substitutes included in the spirit and the technical scope of the present disclosure.

Terms including an ordinary number, such as first and second, are used for describing various components. However, the components are not limited by the terms. The terms are used only to discriminate one component from another component.

It should be understood that, when one constituent element referred to as being “coupled to” or “connected to” another constituent element, one constituent element may be directly coupled to or connected to the other constituent element, but intervening elements may also be present. In contrast, when one constituent element is “directly coupled to” or “directly connected to” another constituent element, it should be understood that there is no intervening element present.

In the present application, it should be appreciated that terms such as “comprising”, “including”, and “having” and variations thereof are intended to designate the existence of characteristics, numbers, operations, operations, components, and components described in the specification or a combination thereof. Such terms do not exclude a possibility of the existence or addition of one or more other characteristics, numbers, operations, operations, components, and components, or a combination thereof in advance.

When a component, unit controller, device, element, apparatus, or the like of the present disclosure is described as having a purpose or performing an operation, function, or the like, the component, unit, controller, device, element, apparatus, or the like should be considered herein as being “configured to” meet that purpose or to perform that operation or function.

In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

Hereinafter, embodiments of the present disclosure are described in detail with reference to the accompanying drawings.

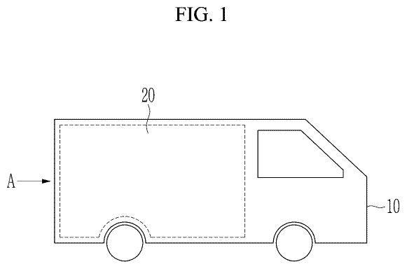

FIG. 1 is a diagram illustrating an example of a vehicle 10 having a cargo compartment 20 for storing cargo according to an embodiment of the present disclosure.

As illustrated in FIG. 1, the vehicle 10 may have a shape that includes the cargo compartment 20 for storing cargo inside. In this case, a rear camera is installed on the rear side of the vehicle 10 to secure rear vision of the vehicle 10. For example, the rear camera may be installed on a rear door 11 or a bumper (not illustrated) of the vehicle.

Due to the nature of the use of the vehicle 10, the vehicle 10 is often driven in reverse with a rear door 11 opened. However, when the rear door 11 is open, the rear camera installed on the rear door 11 captures the view in a direction facing the outer surface of the rear door 11 rather than the rear of the vehicle 10. In other words, when the rear door 11 is open, the rear camera installed on the rear door 11 cannot capture the rear vision of the vehicle 10.

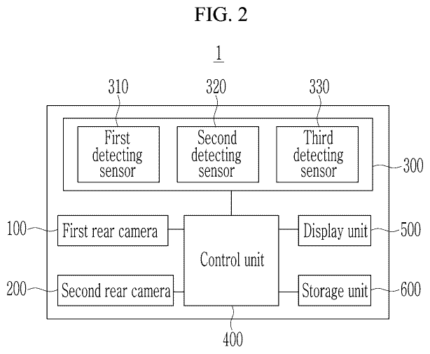

On the other hand, according to a device for securing rear vision of the vehicle 10 according to an embodiment of the present disclosure, it is possible to secure rear vision of the vehicle 10 by using the rear camera even when the driver is driving the vehicle 10 in reverse with the rear door 11 opened. Hereinafter, the device for securing rear vision of the vehicle 10 according to an embodiment of the present disclosure is described with reference to FIGS. 2 to 6.

FIG. 2 is a block diagram illustrating the device for securing rear vision of the vehicle 10 according to an embodiment of the present disclosure.

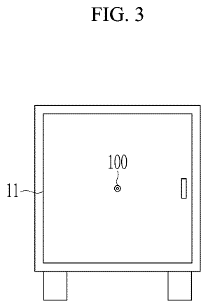

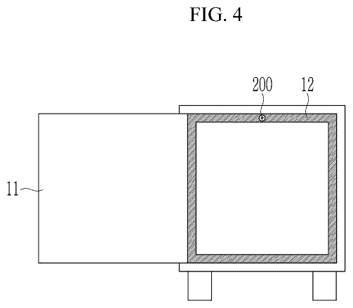

FIG. 3 is a diagram illustrating a rear side of the vehicle 10 according to an embodiment of the present disclosure. FIG. 4 is a diagram illustrating an example of the rear door 11 of the vehicle 10 of FIG. 3 in an open state.

Referring now to FIG. 2, the device for securing rear vision of the vehicle 10 according to an embodiment of the present disclosure may include a first rear camera 100, a second rear camera 200, a sensor unit 300, a control unit 400, and a display unit 500.

In FIGS. 3 and 4, it is illustrated that the number of rear doors 11 of the vehicle 10 is one. However, depending on embodiments, the rear door 11 of the vehicle 10 may include a plurality of rear doors. The following description may apply even when the number of rear doors 11 is plural.

The first rear camera 100 may be installed at the rear side of the vehicle 10 to capture a first rear view image. Depending on an embodiment, the first rear camera 100 may be installed on the rear door 11 or bumper (not illustrated) provided at the rear side of the vehicle 10. The first rear view image refers to an image captured through the first rear camera 100. In FIG. 3, it is illustrated that the first rear camera 100 is installed at the right center of the rear door 11. However, the location of the first rear camera 100 is not limited thereto. The first rear camera 100 may be installed anywhere on the rear door 11. The first rear camera 100 may capture the first rear view image according to a control signal received from the control unit 400. The first rear camera 100 may transmit the captured first rear view image to the display unit 500.

The second rear camera 200 may be installed on an inner edge member 12 of the vehicle 10 that is exposed to the outside when the rear door 11 is open. The inner edge member 12 of the vehicle 10 may be a member that contacts an outer portion of the rear door 11 when the rear door 11 is closed. Depending on an embodiment, the inner edge member 12 may include a locking member (not illustrated) for locking the rear door 11.

The second rear camera 200 may capture a second rear view image. The second rear view image refers to an image captured through the second rear camera 200. In FIG. 4, it is illustrated that the second rear camera 200 is installed at the top right center of the inner edge member 12 of the vehicle 10. However, the location of the second rear camera 200 is not limited thereto. The second rear camera 200 may be installed anywhere as long as the vehicle 10 has the structure that is exposed to the outside by opening the rear door 11. The second rear camera 200 may capture the second rear view image according to a control signal received from the control unit 400. The second rear camera 200 may transmit the captured second rear view image to the display unit 500.

The sensor unit 300 may generate a first sensing signal indicative of a position based on gear shift status of the vehicle 10. The first sensing signal may include information about the position of the gear or gear shifter of the vehicle 10. The information about the position of the gear refers to the position of the gear in a current state, which may include reverse (R), drive (D), neutral (N), and park (P). Depending on an embodiment, the first sensing signal may be generated by a first detecting sensor 310 that detects the position according to the shift of the gear of the vehicle 10. The first detecting sensor 310 may detect the position of the gear of the vehicle 10 by various methods known in the art. For example, the first detecting sensor 310 may be a position sensor installed on the gear, the transmission, the gear shifter, etc. The first sensing signal generated by the sensor unit 300 may be transmitted to the control unit 400.

The sensor unit 300 may generate a second sensing signal indicative of the open state of the rear door 11. According to an embodiment, the second sensing signal may be generated by the second detecting sensor 320 that detects the open of the rear door 11. For example, the second sensing signal may be generated by the second detecting sensor 320 when the second detecting sensor 320 detects that the rear door 11 is open. On the other hand, the second detecting sensor 320 may not generate the second sensing signal when the second detecting sensor 320 does not detect that the rear door 11 is open. The second detecting sensor 320 may detect the opening of the rear door 11 by various methods known in the art. For example, the second detecting sensor 320 may be a pressure sensor installed on a switch member for locking the rear door 11. Alternatively, the second detecting sensor 320 may be a sensor that detects atmospheric pressure inside the vehicle. The second sensing signal generated by the sensor unit 300 may be transmitted to the control unit 400.

The sensor unit 300 may generate a third sensing signal indicative of occurrence of an impact to the vehicle 10. The third sensing signal may include information about the impact that occurred to the vehicle 10. The information about the impact occurring on the vehicle 10 may include a date, time, and place at which the impact occurred to the vehicle 10, and the location within the vehicle 10 where the impact occurred. According to an embodiment, the third sensing signal may be generated by a third detecting sensor 330 that detects whether an impact has occurred to the vehicle 10. The third detecting sensor 330 may detect an impact occurring to the vehicle 10 by a variety of methods known in the art. For example, the third detecting sensor 330 may be an acceleration sensor installed on a bumper or the like of the vehicle 10. The third sensing signal generated by the sensor unit may be transmitted to the control unit 400.

The control unit 400 may receive the first sensing signal to determine whether the gear state of the vehicle 10 is in the reverse state. For example, the control unit 400 may determine that the gear state of the vehicle 10 is in the reverse state when the position of the gear indicated in the first sensing signal is “reverse (R)”. On the other hand, the control unit 400 may determine that the gear state of the vehicle 10 is not in the reverse state when the position of the gear indicated in the first sensing signal is “drive (D)”, “neutral (N)”, or “park (P)”.

The control unit 400 may receive the second sensing signal to determine whether the rear door 11 is open or closed. For example, the control unit 400 may determine that the rear door 11 is open when the control unit 400 receives the second sensing signal from the sensor unit 300. The second sensing signal may be generated by the sensor unit 300 and transmitted to the control unit 400 when the rear door 11 is open.

The control unit 400 may generate a control signal for outputting at least one of the first rear view image and the second rear view image based on a result of the determination of whether the gear state of the vehicle 10 is in the reverse state and a result of the determination of whether the rear door 11 is open or closed. For example, the control unit 400 may generate a control signal for outputting the first rear view image when it is determined that the gear state of the vehicle 10 is in the reverse state and the rear door 11 is the closed state. Alternatively, the control unit 400 may generate a control signal for outputting the second rear view image when it is determined that the gear state of the vehicle 10 is in the reverse state and the rear door 11 is in the open state.

According to an embodiment, the control signal for outputting the first rear view image may include a signal transmitted to the first rear camera 100 and a signal transmitted to the display unit 500. The signal transmitted to the first rear camera 100 is a signal for controlling the first rear camera 100. The signal may be a signal for capturing rear vision of the vehicle 10 through the first rear camera 100 and may be a control signal for transmitting the first rear view image captured through the first rear camera 100 to the display unit 500. The signal transmitted to the display unit 500 is a signal for controlling the display unit 500 and may be a control signal for outputting the first rear view image captured through the first rear camera 100 via the display unit 500.

According to an embodiment, the control signal for outputting the second rear view image may include a signal transmitted to the second rear camera 200 and a signal transmitted to the display unit 500. The signal transmitted to the second rear camera 200 is a signal for controlling the second rear camera 200 and may be a signal for capturing the rear vision of the vehicle 10 through the second rear camera 200 and a control signal for transmitting the second rear view image captured through the second rear camera 200 to the display unit 500. The signal transmitted to the display unit 500 is a signal for controlling the display unit 500 and may be a control signal for outputting the second rear view image captured through the second rear camera 200 via the display unit 500.

According to an embodiment, the control unit 400 may generate a control signal for outputting any one of the first rear view image and the second rear view image in accordance with the driver's selection. In this case, the driver's selection may be input via an input unit (not illustrated) installed on the display unit 500. Information about the driver's selection may be included in the signal generated by the display unit 500 and transmitted to the control unit 400. Depending on an embodiment, the input unit may be a button, a touchscreen, a speaker, or the like. For example, the control unit 400 may provide the driver with an input window to select any one between the first rear view image and the second rear view image via the display unit 500. The control unit 400 may generate a control signal for outputting any one of the first rear view image and the second rear view image based on the driver's selection input via the input window of the display unit 500. As another example, the control unit 400 may generate a control signal for switching the first rear view image that is being output via the display unit 500 to the second rear view image when a driver's selection to output the second rear view image via the display unit 500 is received while the first rear view image is being output via the display unit 500. The same is applied to the contrary case.

The control unit 400 may generate a control signal for storing at least one of the first rear view image and the second rear view image in the storage unit 600 based on a result of the determination of whether the gear state of the vehicle 10 is in the reverse state and a result of the determination of whether the rear door 11 is open or closed. According to an embodiment, the storage unit 600 may be a storage device installed inside a vehicle, such as a black box. For example, the control unit 400 may generate a control signal for storing the first rear view image when it is determined that the gear state of the vehicle 10 is in the reverse state and the rear door 11 is the closed state. Alternatively, the control unit 400 may generate a control signal for storing the second rear view image when it is determined that the gear state of the vehicle 10 is in the reverse state and the rear door 11 is in the open state.

The control signal for storing the first rear view image is a signal transmitted to the first rear camera 100 and may be a control signal for capturing rear vision of the vehicle 10 through the first rear camera 100 and transmitting the first rear view image captured through the first rear camera 100 to the storage unit 600. Depending on an embodiment, the control signal for storing the first rear view image may be a control signal for switching the image that has been transmitted to the storage unit 600 and is being recorded to the first rear view image. For example, when the vehicle 10 is traveling forward, the image that has been transmitted to the storage unit 600 and is being recorded is a front image. The front image means an image captured by a front camera installed on the front of the vehicle 10. Then, when it is detected through the sensor unit 300 that the vehicle 10 is traveling in reverse and the rear door 11 is the closed state, the control unit 400 may generate a control signal for storing the first rear view image and control the image that has been transmitted to the storage unit 600 and is being recorded to be switched from the front image to the first rear view image. Alternatively, when the rear door 11 changes from an open state to a closed state while the vehicle 10 is traveling in reverse, the control unit 400 may generate a control signal for storing the first rear view image and control the image that has been transmitted to the storage unit 600 and is being recorded to be switched from the second rear view image to the first rear view image.

The control signal for storing the second rear view image is a signal transmitted to the second rear camera 200 and may be a control signal for capturing rear vision of the vehicle 10 through the second rear camera 200 and transmitting the second rear view image captured through the second rear camera 200 to the storage unit 600. Depending on an embodiment, the control signal for storing the second rear view image may be a control signal for switching the image that has been transmitted to the storage unit 600 and is being recorded to the second rear view image. For example, when the vehicle 10 is traveling forward, the image that has been transmitted to the storage unit 600 and is being recorded is a front image. The front image means an image captured by a front camera installed on the front of the vehicle 10. Then, when it is detected through the sensor unit 300 that the vehicle 10 is traveling in reverse and the rear door 11 is the open state, the control unit 400 may generate a control signal for storing the second rear view image and control the image that has been transmitted to the storage unit 600 and is being recorded to be switched from the front image to the second rear view image. Alternatively, when the rear door 11 changes from a closed state to an open state while the vehicle 10 is traveling in reverse, the control unit 400 may generate a control signal for storing the second rear view image and control the image that has been transmitted to the storage unit 600 and is being recorded to be switched from the first rear view image to the second rear view image.

The control unit 400 may receive the third sensing signal to determine whether an impact has occurred to the vehicle 10. For example, the control unit 400 may determine that an impact has occurred to the vehicle 10 when the control unit 400 receives the third sensing signal from the sensor unit 300. The third sensing signal may be generated by the sensor unit 300 and transmitted to the control unit 400 when the impact has occurred to the vehicle 10.

According to an embodiment, the control unit 400 may generate a control signal for storing at least one of the first rear view image and the second rear view image in the storage unit 600 when it is determined that the impact has occurred to the vehicle 10. The control signal for storing at least one of the first rear view image and the second rear view image in the storage unit 600 may be transmitted to the first rear camera or the second rear camera, depending on the type of rear camera that is capturing the rear vision of the vehicle.

For example, the control unit 400 may determine that an impact has occurred to the vehicle 10 when the control unit 400 receives the third sensing signal from the sensor unit 300. Further, the control unit 400 may generate a control signal for storing at least one of the first rear view image and the second rear view image in the storage unit 600 based on a result of the determination of whether the impact has occurred. The control unit 400 may transmit the generated control signal to the first rear camera 100 when the rear vision of the vehicle 10 is being captured by the first rear camera 100 and may transmit the generated control signal to the second rear camera 200 when the rear vision of the vehicle 10 is being captured by the second rear camera 200.

According to an embodiment, the control unit 400 may transmit an alarm signal containing information about the impact occurred on the vehicle to an external terminal. The external terminal may be an external server, a user terminal, or the like.

The display unit 500 may be installed inside the vehicle 10. The display unit 500 may display at least one of the first rear view image and the second rear view image according to the input of a control signal. For example, the display unit 500 may output the first rear view image received from the first rear camera 100 when a control signal for outputting the first rear view image is input from the control unit 400. Alternatively, the display unit 500 may output the second rear view image received from the second rear camera 200 when the control unit 400 receives a control signal for outputting the second rear view image. Depending on an embodiment, the display unit 500 may output any one of the first rear view image and the second rear view image, depending on the user's selection.

The storage unit 600 may record the first rear view image received from the first rear camera or the second rear view image received from the second rear camera. According to an embodiment, the storage unit 600 may be a storage device installed inside the vehicle 10, such as a black box.

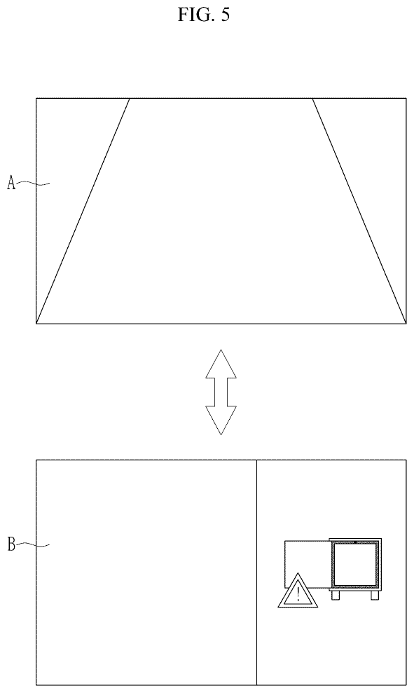

FIG. 5 is a diagram illustrating the switching of an image output to the display unit 500 through the device for securing rear vision of the vehicle according to an embodiment of the present disclosure.

In FIG. 5, A illustrates a first rear view image being provided through the display unit 500, and B illustrates a second rear view image being provided through the display unit 500. However, A and B in FIG. 5 correspond to one example of the first rear view image and the second rear view image provided via the display unit 500. The configuration of the display unit 500 providing the first and second rear view images and the content of the first and second rear view images are not limited thereto. Depending on an embodiment, the screen in the display unit 500 providing the first rear view image and the second rear view image may be varied.

Referring to FIG. 5, the control unit 400 according to one embodiment of the present disclosure may generate a control signal for switching the rear view image output via the display unit 500 based on a result of the determination of whether the gear state is in the reverse state and a result of the determination of whether the rear door 11 is open or closed.

For example, there may be a case where the rear door 11 of the vehicle 10 is closed and then the rear door 11 of the vehicle 10 is changed to an open state while traveling in reverse. In this case, the control unit 400 may first generate a control signal for outputting the first rear view image A and control the first rear view image A captured by the first rear camera 100 to be output via the display unit 500. Then, when the opening of the rear door 11 is detected, the control unit 400 may control the first rear view image A that is being output via the display unit 500 to switch to the second rear view image B.

Alternatively, there may be a case where the rear door 11 of the vehicle 10 is open and then the rear door 11 of the vehicle 10 is changed to a closed state while traveling in reverse. In this case, the control unit 400 may first generate a control signal for outputting the second rear view image B and control the second rear view image B captured by the second rear camera 200 to be output via the display unit 500. Then, when the close of the rear door 11 is detected, the control unit 400 may control the second rear view image B that is being output via the display unit 500 to switch to the first rear view image A.

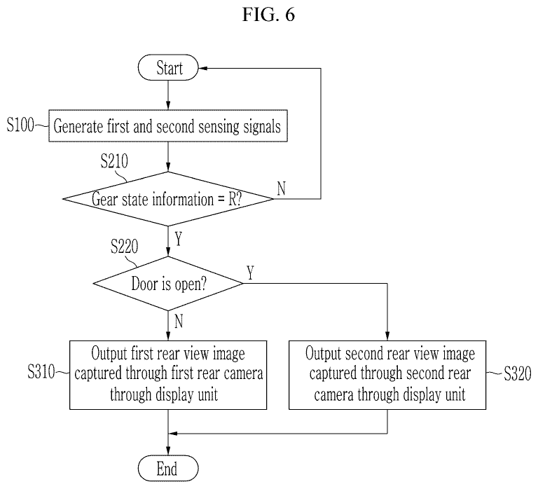

FIGS. 6-8 are flowcharts illustrating a method of securing rear vision of a vehicle 10 according to an embodiment of the present disclosure.

Referring to FIG. 6, a method of securing rear vision of the vehicle 10 having the compartment 20 for storing cargo according to an embodiment of the present disclosure may include a sensing signal generation operation S100, a gear and rear door state determination and control signal generation operation S200, and a rear view image output operation S300.

In the sensing signal generation operation S100, the sensor unit 300 may generate a first sensing signal indicating a position according to the shift of the gear of the vehicle 10 and a second sensing signal indicating a state in which the rear door 11 is open. The first sensing signal may be generated by the first detecting sensor 310 that detects the position according to the shift of the gear of the vehicle 10. The second sensing signal may be generated by the second detecting sensor 320 that detects the opening of the rear door 11. The first sensing signal and the second sensing signal may be transmitted to the control unit 400 from the first and second detecting sensors 310 and 320, respectively.

According to an embodiment, the sensing signal generation operation S100 may include an operation of detecting, by the first detecting sensor 310, a position according to the shift of the gear of the vehicle 10 to generate a first sensing signal, and an operation of detecting, by the second detecting sensor 320, an opening of the rear door 11 to generate a second sensing signal.

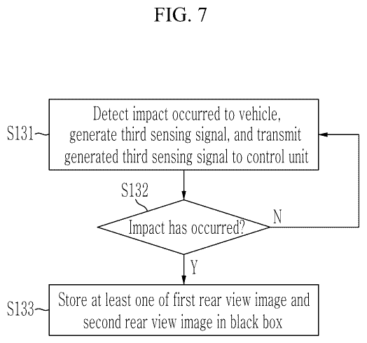

Referring to FIG. 7, the sensing signal generation operation S100 according to an embodiment of the present disclosure may further include operation S131 of detecting, by the third detecting sensor 330, an impact occurring to the vehicle 10 and generating a third sensing signal, and transmitting the generated third sensing signal to the control unit 400. The sensing signal generation operation S100 may further include operation S132 of determining, by the control unit 400, whether the impact has occurred to the vehicle 10 by receiving the third sensing signal. The sensing signal generation operation S100 may also include operation S133 of generating, by the control unit 400, a control signal for storing at least one of the first rear view image and the second rear view image in the storage unit 600 according to a result of determination of whether the impact has occurred.

In the gear and rear door state determination and control signal generation operation S200, the control unit 400 may receive a first sensing signal to determine whether the gear state of the vehicle 10 is in a reverse state. The control unit 400 may receive a second sensing signal to determine whether the rear door 11 is open or closed. The control unit 400 may generate a control signal for outputting at least one of a first rear view image and a second rear view image based on a result of the determination of whether the gear state of the vehicle 10 is in the reverse state and a result of the determination of whether the rear door 11 is opened or closed. The control signal may be transmitted from the control unit 400 to the first rear camera 100, the second rear camera 200, and the display unit 500.

According to an embodiment, the gear and rear door state determination and control signal generation operation S200 may include operation S210 of determining, by the control unit 400, that the gear state of the vehicle 10 is in the reverse state when the position of the gear indicated in the first sensing signal is in a “reverse” position. The gear and rear door state determination and control signal generation operation S200 may further include operation S220 of determining, by the control unit 400, that the rear door 11 is open when the second sensing signal is received from the sensor unit 300.

According to an embodiment, the gear and rear door state determination and control signal generation operation S200 may include an operation of generating, by the control unit 400, a control signal for outputting the first rear view image when it is determined that the gear state of the vehicle 10 is in the reverse state and the rear door 11 is in a closed state. The gear and rear door state determination and control signal generation operation S200 may also include an operation of generating, by the control unit 400, a control signal for outputting the second rear view image when it is determined that the gear state of the vehicle 10 is in the reverse state and the rear door 11 is in the open state.

According to an embodiment, the gear and rear door state determination and control signal generation operation S200 may include an operation of generating, by the control unit 400, a control signal for storing the first rear view image when it is determined that the gear state of the vehicle 10 is in the reverse state and the rear door 11 is in the closed state. The gear and rear door state determination and control signal generation operation S200 may also include an operation of generating, by the control unit 400, a control signal for storing the second rear view image when it is determined that the gear state of the vehicle 10 is in the reverse state and the rear door 11 is in the open state.

In the rear view image output operation S300, the display unit 500 may output at least one of the first rear view image and the second rear view image according to the input of the control signal. For example, the display unit 500 may receive the first rear view image from the first rear camera 100 and output the received first rear view image when the control signal for outputting the first rear view image is received from the control unit 400. In this case, the first rear view image refers to an image captured through the first rear camera 100. Alternatively, the display unit 500 may receive the second rear view image from the second rear camera 200 and output the received second rear view image when the control signal for outputting the second rear view image is received from the control unit 400. In this case, the second rear view image refers to an image captured through the second rear camera 200.

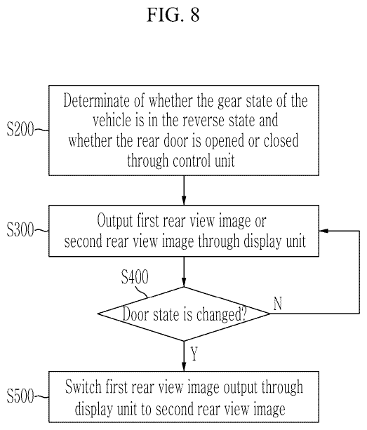

Referring to FIG. 8, the method of securing rear vision of the vehicle 10 according to an embodiment of the present disclosure may further include a rear door state change determination operation S400 and a rear view image switching operation S500.

In the rear door state change determination operation S400, the control unit 400 may determine whether the state of the rear door 11 has changed in the vehicle 10 in which the gear state is in the reverse state. According to an embodiment, the control unit 400 may determine the change in state of the rear door 11 based on whether the second sensing signal is received during a predetermined time period. For example, in the case of the vehicle 10 being traveling in reverse with the rear door 11 in the closed state, the control unit 400 does not continuously receive the second sensing signal from the sensor unit 300. In this case, the control unit 400 may determine that the rear door 11 has changed from the closed state to the open state when the second sensing signal received from the sensor unit 300 is present during the predetermined time period. Alternatively, in the case of the vehicle 10 being travelling in reverse with the rear door 11 open, the control unit 400 may continuously receive the second sensing signal from the sensor unit 300. In this case, the control unit 400 may determine that the rear door 11 has changed from the open state to the closed state when there is no second sensing signal received from the sensor unit 300 during the predetermined time period.

In the rear view image switching operation S500, the control unit 400 may generate a control signal for switching the rear view image output via the display unit 500 according to a result of the determination of whether the state of the rear door 11 has changed. For example, when the rear door 11 of the vehicle 10 is in the closed state while driving in reverse, and the rear door 11 of the vehicle 10 changes to the open state, the control unit 400 may control the first rear view image that is being output via the display unit 500 to be switched to the second rear view image. Alternatively, when the rear door 11 of the vehicle 10 is in the open state while driving in reverse, and the rear door 11 of the vehicle 10 changes to the closed state, the control unit 400 may control the second rear view image that is being output via the display unit 500 to be switched to the first rear view image.

The method described above may be implemented in a general-purpose digital computer that may be written as a program executable on a computer, and that operates the program using a computer-readable recording medium. The computer-readable recording medium may include a storage medium, such as a magnetic storage medium such as a ROM, RAM, USB, floppy disk, hard disk, or an optical reading medium, such as a CD-ROM or DVD.

The scope of the present disclosure is indicated by the following patent claims rather than by the detailed description above. The meaning and scope of the claims and all modifications or variations derived from the equivalents thereof shall be construed to be included in the scope of the present disclosure.

What is claimed is:

1. A device for obtaining a rear view of a vehicle having a cargo compartment for storing cargo, the device comprising:
a first rear camera installed on a rear side of the vehicle and configured to capture a first rear view image;
a second rear camera installed on an inner edge portion of the vehicle that is exposed to the outside when a rear door is open, the second rear camera configured to capture a second rear view image;
a sensor unit configured to generate a first sensing signal indicative of a position according to shift of a gear of the vehicle and a second sensing signal indicative of a state in which the rear door is open;
a control unit configure to
receive the first and second sensing signals,
determine whether a state of the gear of the vehicle is in a reverse state and whether the rear door is open or closed, and
generate a control signal for outputting at least one of the first rear view image or the second rear view image according to a result of the determination; and
a display unit installed inside the vehicle and configured to display at least one of the first rear view image or the second rear view image according to an input of the control signal.

2. The device of claim 1, wherein the first rear camera is installed on the rear door of the vehicle.

3. The device of claim 1, wherein the sensor unit includes:
a first detecting sensor configured to detect a position based on the shift of the gear of the vehicle; and
a second detecting sensor configured to detect an opening of the rear door.

4. The device of claim 1, wherein the sensor unit includes a third detecting sensor configured to detect an impact occurring to the vehicle and generate a third sensing signal indicating that the impact has occurred to the vehicle.

5. The device of claim 4, wherein, when the control unit receives the third sensing signal from the third detecting sensor, the control unit is configured to determine that the impact has occurred to the vehicle and generate a control signal for storing at least one of the first rear view image or the second rear view image in a storage unit.

6. The device of claim 1, wherein the control unit is configured to determine that the state of the gear of the vehicle is in a reverse state when the position of the gear indicated in the first sensing signal is in a reverse position.

7. The device of claim 1, wherein when the control unit receives the second sensing signal from the sensor unit, the control unit is configured to determine that the rear door is open.

8. The device of claim 1, wherein the control unit is configured to generate a control signal for outputting the first rear view image when it is determined that the state of the gear of the vehicle is in the reverse state and the rear door is in a closed state.

9. The device of claim 1, wherein the control unit is configured to generate a control signal for outputting the second rear view image when it is determined that the state of the gear of the vehicle is in the reverse state and the rear door is in an open state.

10. The device of claim 1, wherein the control unit is configured to generate a control signal for switching a rear view image output through the display unit according to a result of the determination of whether the state of the gear of the vehicle is in the reverse state and a result of the determination of whether the rear door is open or closed.

11. The device of claim 1, wherein the control unit is configured to generate a control signal for storing the first rear view image when it is determined that the state of the gear of the vehicle is in the reverse state and the rear door is in a closed state.

12. The device of claim 1, wherein the control unit is configured to generate a control signal for storing the second rear view image when it is determined that the state of the gear of the vehicle is in the reverse state and the rear door is in an open state.

13. A method for obtaining a rear view of a vehicle having a cargo compartment for storing cargo, the method comprising:
generating, by a sensor unit, a first sensing signal indicative of a position according to shift of a gear of the vehicle and a second sensing signal indicative of a state in which a rear door installed at a rear side of the vehicle is open;
receiving, by a control unit, the first and second sensing signals;
determining, by the control unit, whether a state of the gear of the vehicle is in a reverse state and whether the rear door is open or closed;
generating, by the control unit, a control signal for outputting at least one of the first rear view image or the second rear view image according to a result of the determination; and
outputting, by a display unit, at least one of the first rear view image or the second rear view image according to an input of the generated control signal.

14. The method of claim 13, wherein generating the second sensing signal includes:
detecting, by a first detecting sensor, a position according to the shift of the gear of the vehicle;
generating, by the first detecting sensor, the first sensing signal;
detecting, by a second detecting sensor, an opening of the rear door; and
generating, by the second detecting sensor, the second sensing signal.

15. The method of claim 13, wherein generating the second sensing signal further includes:
detecting, by a third detecting sensor, an impact occurring to the vehicle;
generating, by the third detecting sensor, a third sensing signal;
receiving, by the control unit, the third sensing signal to determine whether the impact has occurred to the vehicle; and
generating, by the control unit, a control signal for storing at least one of the first rear view image or the second rear view image in a storage unit according to a result of the determination of whether the impact has occurred to the vehicle.

16. The method of claim 13, wherein generating the control signal includes:
determining that the state of the gear of the vehicle is in a reverse state when a position of the gear indicated in the first sensing signal is in a reverse position; and
when the second sensing signal is received from the sensor unit, determining that the rear door is open.

17. The method of claim 13, wherein generating the control signal includes:
generating a control signal for outputting the first rear view image when it is determined that the state of the gear of the vehicle is in the reverse state and the rear door is in a closed state; and
generating a control signal for outputting the second rear view image when it is determined that the state of the gear of the vehicle is in the reverse state and the rear door is in an open state.

18. The method of claim 13, wherein generating the control signal includes:
generating a control signal for storing the first rear view image when it is determined that the state of the gear of the vehicle is in the reverse state and the rear door is in a closed state; and
generating a control signal for storing the second rear view image when it is determined that the state of the gear of the vehicle is in the reverse state and the rear door is in an open state.

19. The method of claim 13, further comprising:
determining, by the control unit, whether opening and closing of the rear door of the vehicle of which the state of the gear is in the reverse state has changed; and
generating a control signal for switching a rear view image output through the display unit according to a result of determining whether the opening and closing of the rear door has changed.
